(19) United States
(12) Patent Application Publication
(10) Pub. No.: US 2010/0136419 A1
(43) Pub. Date: Jun. 3, 2010

(54) Battery pack

(75) Inventors: Eunok Kwak, Yongin-si (KR); Youngcheol Jang, Yongin-si (KR); Kyungwon Seo, Yongin-si (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., Ltd., Suwon-si (KR)

(21) Appl. No.: 12/591,830

(22) Filed: Dec. 2, 2009

(30) Foreign Application Priority Data
Dec. 3, 2008 (KR) 10-2008-0121879

(51) Int. Cl. H01M 2/02

(52) U.S. Cl. 429/164

(57) ABSTRACT

Disclosed is a battery pack that can improve bonding strength between a bare cell and a case by combining a beading part of a bare cell with a projection on an inner surface of a case. The battery pack comprises a bare cell and an upper case. The bare cell includes an electrode assembly, a can receiving the electrode assembly, and a cap assembly covering an upper part of the can. The can includes a beading part inwardly pressed from an outer surface of the can. The beading part is at a higher position than an upper part of the electrode assembly. The upper case covers the beading part and upper part of the can, and includes a projection formed on an inner surface of the upper case. The projection is combined with the beading part of the can.

### CLAIM OF PRIORITY

This application makes reference to, incorporates the same herein, and claims all benefits accruing under 35 U.S.C. §119 from an application earlier filed in the Korean Intellectual Property Office on 3 Dec. 2008 and there duly assigned Serial No. 10-2008-0121879.

### BACKGROUND OF THE INVENTION

1. Field of the Invention

The present invention relates to a battery, and more particularly, to a battery pack that can improve bonding strength between a bare cell and a case.

2. Description of the Related Art

Generally, a lithium ion battery pack is provided to a consumer in a state that a core pack including a bare cell and a protection circuit module is wrapped with an outer case.

Recently, simpler and smaller battery packs having the same functions have been developed with tendency of development of lightweight and small-sized electronic devices. Accordingly, there have been continuously performed researches to simplify manufacturing process, to integrate elements with each other, and to make them compact.

### SUMMARY OF THE INVENTION

An object of the present invention is to provide a battery pack that can improve bonding strength between a bare cell and a case.

Additional advantages, objects and features of the invention will be set forth in part in the description which follows and in part will become apparent to those having ordinary skill in the art upon examination of the following or may be learned from practice of the invention.

According to one aspect of the present invention, there is provided a battery pack, which includes a bare cell and an upper case. The bare cell includes an electrode assembly for producing electricity, a can receiving the electrode assembly, and a cap assembly covering an upper part of the can. The can includes a beading part inwardly pressed from an outer surface of the can. The beading part is formed at a higher position than an upper part of the electrode assembly. The upper case covers the beading part and the upper part of the can. The upper case includes a projection formed on an inner surface of the upper case. The projection is combined with the beading part.

More than one projection may be provided on an inner surface of the upper case. Two of the projections may face each.

The projection may have a bar or ring shape. A portion of the ring-shaped projection may be opened.

The battery pack may further include a protection circuit module electrically coupled to the bare cell. The protection circuit module may include a first module electrically coupled to a first electrode terminal of the bare cell and being substantially disk-shaped, a second module electrically coupled to a second electrode terminal of the bare cell and being substantially disk-shaped and a third module electrically coupling the first module to the second module.

The first module may include a first substrate, a first plate provided at the middle of the substrate and a device mounting portion provided on an inner surface of the first substrate, the device mounting portion surrounding the first plate.

The device mounting portion may be arranged in a groove formed between the first electrode terminal and can of the bare cell.

Each of the first, second and third modules may respectively include a flexible printed circuit board.

The first module may be disposed between the bare cell and the upper case.

The battery pack may further include a lower case provided at a lower part of the bare cell.

According to another aspect of the present invention, there is provided a battery pack, which includes a bare cell and a protection circuit module electrically coupled to the bare cell. The bare cell includes an electrode assembly for producing electricity, a can receiving the electrode assembly, and a cap assembly covering an upper part of the can. The can includes a beading part inwardly pressed from an outer surface of the can. The beading part is formed at a higher position than an upper part of the electrode assembly. The protection circuit module includes a first module electrically coupled to a first electrode terminal of the bare cell and being substantially disk-shaped, a second module electrically coupled to a second electrode terminal of the bare cell and being substantially disk-shaped, and a third module electrically coupling the first module to the second module.

The battery pack may further include an upper case covering the beading part and the upper part of the can. The upper case may include a projection formed on an inner surface of the upper case. The projection is combined with the beading part.

The first module may be disposed between the bare cell and the upper case.

More than one projection may be provided on the inner surface of the upper case. Two of the projections may face each other.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view illustrating a battery pack according to one exemplary embodiment of the present invention;

FIG. 2 is a sectional view illustrating a bare cell and an upper case of the battery pack;

FIG. 3 is a perspective view illustrating the upper case;

FIG. 4 is a bottom view illustrating the upper case;

FIG. 5 is an exploded perspective view illustrating a battery pack according to another exemplary embodiment of the present invention;

FIG. 6 is a perspective view illustrating a first module according to the another exemplary embodiment;

FIG. 7 is a perspective view illustrating a second module according to the another exemplary embodiment;

FIG. 8 is a front view illustrating the battery pack according to the another exemplary embodiment; and

FIGS. 9 to 13 are bottom views illustrating upper cases according to other various exemplary embodiments of the present invention.

### DETAILED DESCRIPTION OF EXEMPLARY EMBODIMENTS

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

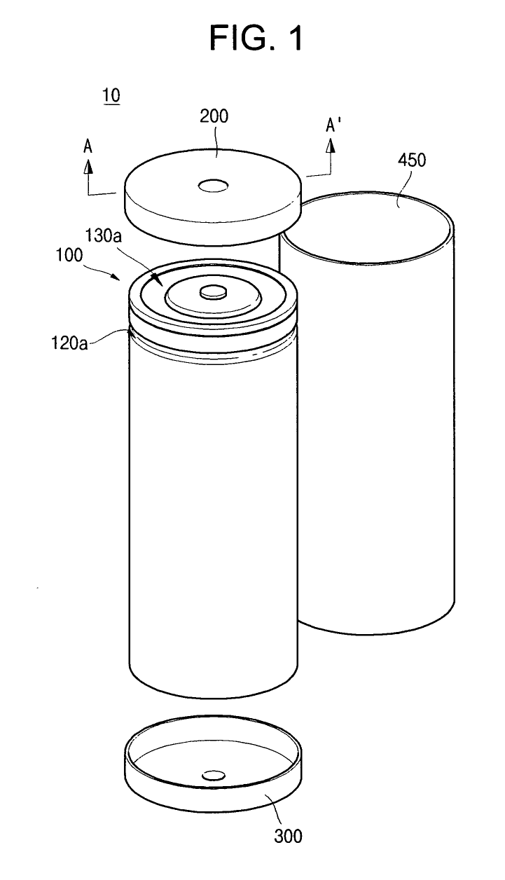

FIG. 1 is an exploded perspective view illustrating a battery pack 10 according to one exemplary embodiment of the present invention. Referring to FIG. 1, the battery pack 10 includes a bare cell 100, an upper case 200, a lower case 300 and a label 450.

The bare cell 100 includes basic elements for performing a battery function, that is, an electrode assembly 110 and a cap assembly 130 placed in a can 120. A beading part 120a is formed at an upper part of the can 120 to prevent movement of the electrode assembly 110. Upper and lower parts of the bare cell 100 are respectively combined with the upper and lower cases 200 and 300, respectively. Then, an outer surface of the bare cell 100 is wrapped with the label 450. A projection of the upper case 200 is combined with the beading part 120a to improve bonding strength of the battery pack. The bare cell 100 and upper case 200 will be explained in detail below.

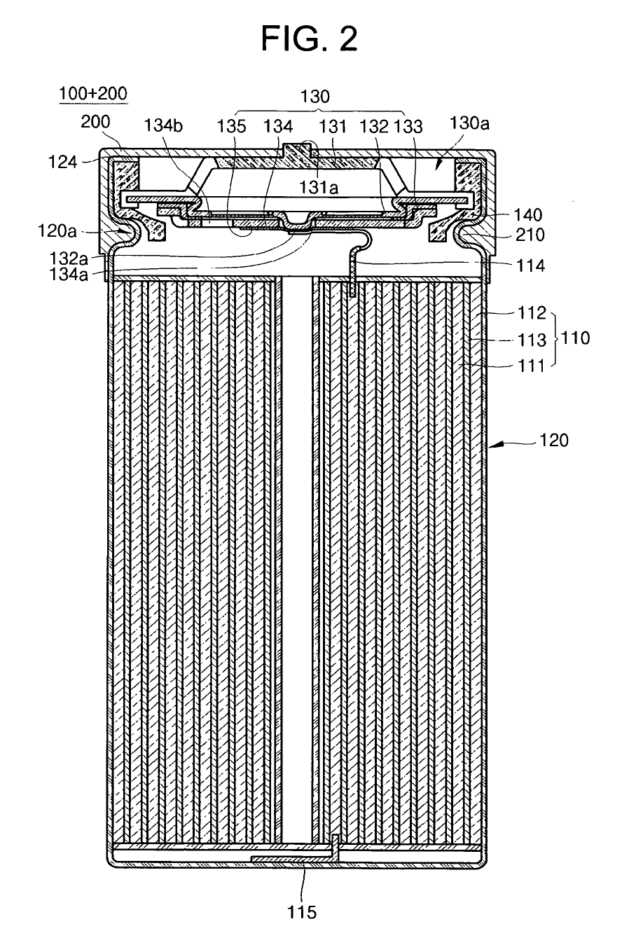

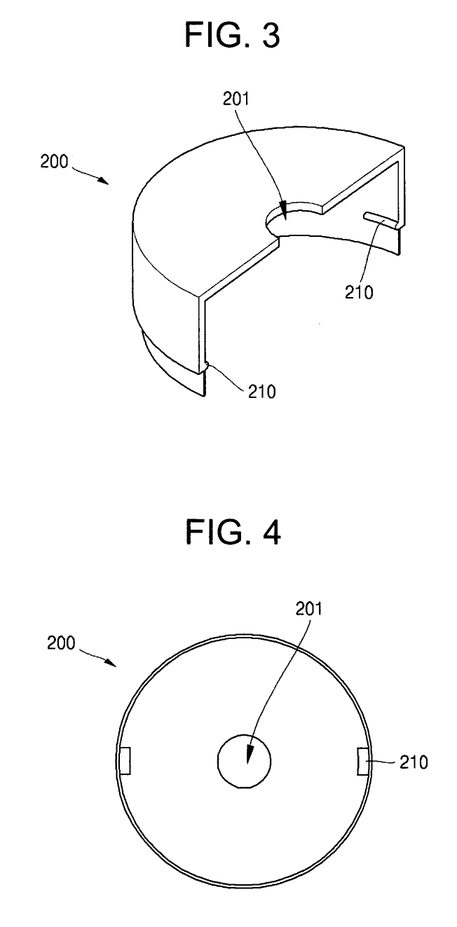

FIG. 2 is a sectional view illustrating the bare cell 100 and upper case 200 of the battery pack 10. FIGS. 3 and 4 are respectively perspective and sectional views illustrating the upper case 200. FIG. 2 is the sectional view taken along an A-A′ line. FIG. 3 is the sectional view taken by cutting the upper case 200 in halves about the center of the upper surface thereof to illustrate the inside of the upper case 200.

Referring to FIG. 2, the bare cell 100 includes the electrode assembly 110, the can 120 receiving the electrode assembly 110, and the cap assembly 130 covering an upper opening of the can 120.

The can 120 has a cylindrical shape and an upper opening. The can 120 is made of metal and can function as a terminal in itself. The electrode assembly 110 can be inserted through the upper opening of the can 120. The beading part 120a is formed at the upper part of the can 120 in order to prevent movement of the electrode assembly 110. The beading part 120a is formed by inwardly pressing an outer surface of the can 120 after the electrode assembly 110 is inserted into the can 120. The beading part 120a is formed to correspond to the upper part of the electrode assembly 110. In other words, the beading part 120a has a form of a groove formed by inwardly pressing a portion of the can 120 just above the upper part of the electrode assembly 110. A crimping part 124 is formed at the uppermost part of the can 120 in order to fix the cap assembly 130. The can 120 can function as an anode terminal, that is, a second electrode terminal. More particularly, the lower surface of the can 120 can function as the second electrode terminal.

The electrode assembly 110 includes first and second electrode plates 111 and 112 and a separator 113. The electrode assembly 110 may be formed by interposing the separator 113 between the first and second electrode plates 111 and 112 and winding them in a jelly-roll type.

The first electrode plate 111 includes a first electrode collector (not shown) and a first electrode coating portion (not shown). The first electrode collector is made of aluminum (Al) foil having excellent conductivity when the first electrode plate 111 is a cathode.

The first electrode coating portion is provided on the first electrode collector and formed of a first electrode active material, conductive material and binder. The first electrode active material may be lithium cobalt oxide (LiCoO₂), lithium manganese oxide (LiMn₂O₄) or lithium nickel oxide (LiNiO₂). The conductive material may be carbon black. The binder may be PVDF, SBR or PTFE dissolved and dispersed in a volatile solvent such as NMP, an organic solvent or water.

Both ends of the first electrode collector are provided with a first electrode non-coating portion (not shown) where the first electrode coating portion is not formed. A first electrode tab 114 is attached to the first electrode non-coating portion and projected toward the upper opening of the can 120. The first electrode tab 114 may be made of aluminum.

The second electrode plate 112 includes a second electrode collector (not shown) and a second electrode coating portion (not shown). The second electrode collector is made of copper (Cu) foil having excellent conductivity when the second electrode plate 112 is an anode.

The second electrode coating portion is provided on the second electrode collector and formed of a second electrode active material, conductive material and binder. The second electrode active material may be carbon (C) material, Si, Sn, tin oxide, composite tin alloy, transition metal oxide, lithium metal nitride or lithium metal oxide. Typically, carbonic material may be used as the second electrode active material. The conductive material may be carbon black. The binder may be PVDF, SBR or PTFE dissolved and dispersed in a volatile solvent such as NMP, an organic solvent or water. The conductive material may not be used in the second electrode plate 112 because conductivity of the second electrode active material itself is high.

Both ends of the second electrode collector are provided with a second electrode non-coating portion where the second electrode coating portion is not formed. A second electrode tab 115 is attached to the second electrode non-coating portion and projected toward the upper opening of the can 120. The second electrode tab 115 may be made of copper (Cu) or nickel (Ni).

The separator 113 may be a porous film made of polyethylene (PE), polypropylene (PP) or composite film thereof. The separator 113 interrupts electron conduction between the first and second electrode plates 111 and 112 in the electrode assembly 110 and allows lithium ions to move smoothly. The separator 113 prevents contact between the first and second electrode plates 111 and 112 and also prevents temperature increase through shut-down, etc. when the temperature of the battery pack 10 is increased by an external short.

In the electrode assembly 110, lithium ions move from the first electrode plate 111 to the second electrode plate 112 at the time of charging and are intercalated thereto. At the time of discharging, lithium ions are deintercalated from the second electrode plate 112 to the first electrode plate 111, thereby allowing voltage to be applied to an external device.

The cap assembly 130 includes a cap-up 131, a safety vent 132, a cap-down 134, an insulator 133 and a sub-plate 135. The cap-up 131 is electrically coupled to the electrode assembly 110 and transmits current generated in the electrode assembly 110 to an external device. An upper surface of the safety vent 132 is contacted to a lower surface of the cap-up 131 and interrupts current, and discharges internal gas when abnormal internal pressure is generated in the can 120. The cap-down 134 is provided below the safety vent 132 to seal the can 120. The insulator 133 is interposed between the safety vent 132 and cap-down 134. The sub-plate 135 is fixed to a lower surface of the cap-down 134 and the first electrode tab 114 is attached to the sub-plate 135.

The cap-up 131 is formed in a shape of a circular plate and includes a terminal projection 131a projected from the middle part thereof, where the terminal projection 131a is combined with a terminal hole of the upper case. The cap-up 131 can function as the first electrode terminal, that is, a cathode terminal.

The safety vent 132 is formed of a circular plate corresponding to the cap-up 131 and a projection part 132a is projected downward from the middle part thereof. The cap-up 131 and safety vent 132 are combined prior to other components of the cap assembly 130.

The combined cap-up 131 and safety vent 132 are seated on an inner circumference surface of a gasket 140 provided at the upper opening of the can 120 and assembled by pressing the gasket 140 to the outer circumference surface of the cap-up 131.

The insulator 133 is interposed between the safety vent 132 and cap-down 134, and made of material insulating them from each other.

The cap-down 134 is formed of a circular plate and a middle through-hole 134a is formed in the middle of the cap-down 134. The projection part 132a of the safety vent 132 passes through the middle through-hole 134a. A gas discharge hole 134b is formed at one side of the cap-down 134. When the internal pressure is excessively increased, gas is discharged through the gas discharge hole 134b to move up the projection part 132a.

The sub-plate 135 is welded to the projection part 132a of the safety vent 132 passing through the middle through-hole 134a of the cap-down 134 to couple the first electrode tab 114 to the safety vent 132 electrically.

In addition, a PTC (not shown) device as a secondary protective device may be further provided between the cap-up 131 and safety vent 132.

Referring to FIGS. 2, 3 and 4, the upper case 200 is arranged to cover the beading part 120a and the upper part of the can 120. The upper case 200 includes a disc type upper surface provided on the bare cell 100 and a side surface extended toward the bare cell 100 from an outer circumference of the upper surface. A terminal hole 201 is formed on the upper surface of the upper case 200, thereby allowing the terminal projection 131a of the cap-up 131 to be projected outward.

A bar type projection 210 is provided on the inner surface of the upper case 200. At least one projection 210 may be provided on the inner surface of the upper case 200. Referring to FIGS. 3 and 4, two projections 210 may be provided to face each other. The upper case 200 and projection 210 may be made of plastic.

The projection 210 of the upper case 200 is combined with the beading part 120a of the bare cell 100. More particularly, the projection 210 on the inner surface of the upper case 200 may be combined with the beading part 120a of the can 120 by an interference fit method. According to the interference fit method, a hole and a shaft are tightly combined with each other when the shaft is inserted into the hole.

The projection 210 has the same width and depth as those of the beading part 120a. As described above, the beading part 120a is a groove that is formed concave at the upper part of the can 120. Thus, bonding strength between the upper case 200 and bare cell 100 can be improved by the interference fit method because the projection 210 has the same width and depth as those of the beading part 120a.

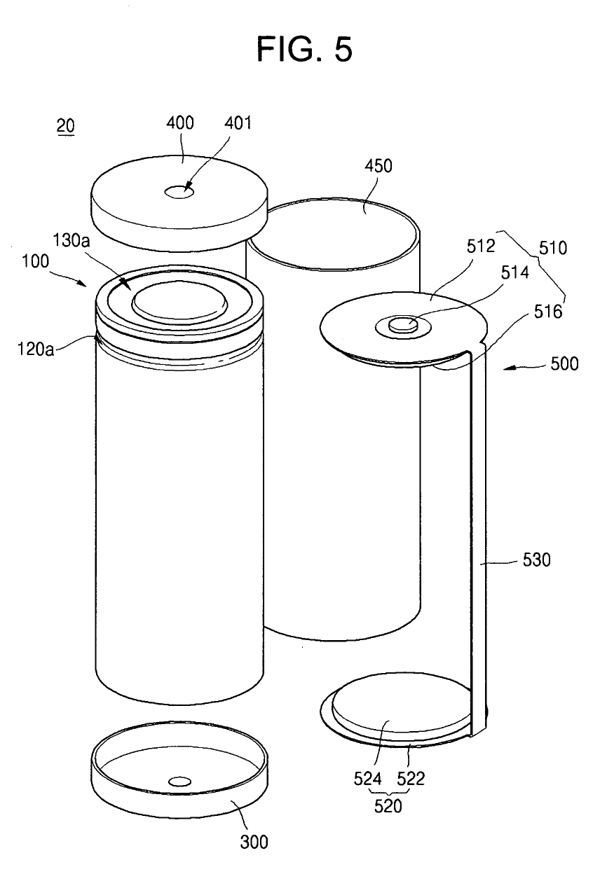

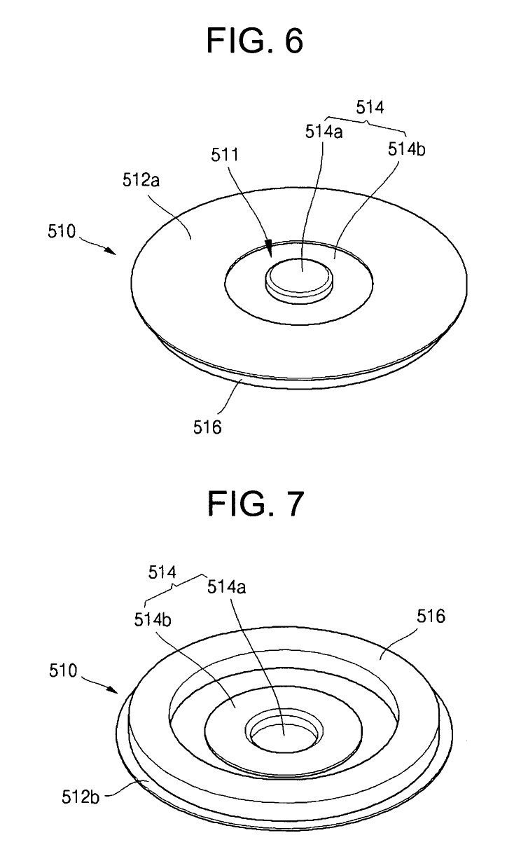

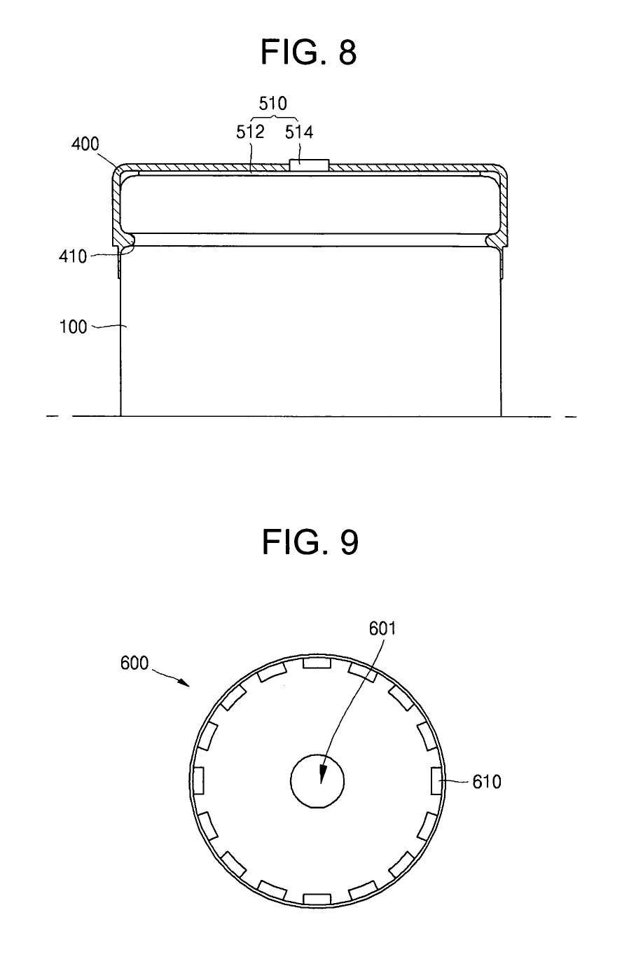

FIG. 5 is an exploded perspective view illustrating a battery pack according to another exemplary embodiment of the present invention, and FIGS. 6 and 7 are perspective views respectively illustrating first and second modules according to the another exemplary embodiment and FIG. 8 is a front view illustrating the battery pack according to the another exemplary embodiment.

Referring to FIGS. 5 to 7, the battery pack 20 includes a bare cell 100, an upper case 400, a lower case 300, a label 450 and a protection circuit module 500. The battery pack 20 is the same as the battery pack 10 shown in FIGS. 1 to 4 except that it further includes a protection circuit module 500.

The protection circuit module 500 includes a first module 510, a second module 520 and a third module 530.

The first module 510 is provided on an upper surface of the bare cell 100. The first module 510 includes a first substrate 512, a first plate 514 and a device mounting portion 516.

The first substrate 512 is formed of a disc type flexible printed circuit board (FPCB). A plurality of printed circuit patterns (not shown) connected to the first plate 514 and device mounting portion 516 may be formed on the first substrate 512. A circular hole 511 is formed in the middle of the first substrate 512. The first substrate 512 has an outer surface 512a facing the upper case 400 and an inner surface 512b facing a first electrode terminal.

The first plate 514 is arranged in the middle of the inner surface 512b of the first substrate 512. The first plate 514 includes a projected portion 514a protruded outward through the hole 511 of the first substrate 512 and a flat portion 514b soldered to the inner surface 512b of the first substrate 512. The first electrode terminal, that is, a cap-up 131 is welded to the flat portion 514b of the first plate 514. The projected portion 514a of the first plate 514 can be connected to the exterior through a terminal hole 401 of the upper case 400. Thus, the cap-up 131 may not include a terminal projection.

The device mounting portion 516 is arranged at an outer part (away from a center) of the inner surface 512b of the first substrate 512 and has a ring shape. In other words, the device mounting portion 516 is arranged on the inner surface of the first substrate 512 and surrounds the first plate 514 with a predetermined gap from the first plate 514. In the device mounting portion 516, passive and active elements including a protection circuit may be electrically coupled to a conductive metal pattern. The protection circuit protects the battery through checking information such as charging/discharging state, current, voltage and temperature of the battery. When the protection circuit module 500 is combined with the bare cell 100, the device mounting portion 516 is arranged in a groove (or a space) 130a formed between the first electrode terminal and can 120 of the bare cell 100.

The second module 520 is provided on a lower surface of the bare cell 100. The second module 520 includes a second substrate 522 and a second plate 524.

The second substrate 522 is formed of a disc type flexible printed circuit board. A plurality of printed circuit patterns (not shown) connected to the second plate 524 and device mounting portion 516 may be formed on the second substrate 522.

The second plate 524 is arranged in the middle of the surface of the second substrate 522 facing the bare cell. The second plate 524 has a flat disc shape. A lower surface of the can 120, that is, a second electrode terminal is welded to the second plate 524.

The third module 530 is arranged outside the bare cell 100 along a length direction of the bare cell 100. The third module 530 has a stripe shape. The third module 530 electrically couples the first substrate 512 of the first module 510 to the second substrate 522 of the second module 520. The third module 530 is formed of a flexible printed circuit board.

The first module 510 of the protection circuit module 500 is electrically coupled to the cap-up 131, that is, the first electrode terminal of the bare cell 100. More particularly, the first plate 514 of the first module 510 is electrically coupled to the upper surface of the cap-up 131 of the bare cell 100.

The ring-shaped groove 130a is formed between a side surface of the cap-up 131 of the bare cell 100 and a gasket 140. When the first module 510 is combined with the bare cell 100, the device mounting portion 516 of the first module 510 is arranged in the groove 130a formed between the cap-up 131 and gasket 140. The device mounting portion 516 is arranged in the groove 130a between the cap-up 131 and can 120 in the usually manufactured bare cell 100, thereby removing installation space of the device mounting portion 516 in the secondary battery. Thus, the secondary battery can be slimmed.

Referring to FIG. 8 and FIGS. 5 to 7, the upper case 400 is arranged to cover the beading part 120a and the upper part of the can 120 after the bare cell 100 is electrically and physically combined with the protection circuit module 500. In this time, the projected portion 514a of the first plate 514 of the protection circuit module 500 provided on the upper surface of the bare cell 100 is partially protruded outward through the terminal hole 401 of the upper case 400.

A bar type projection 410 is provided on the inner surface of the upper case 400. Two projections 410 may be provided to face each other on the inner surface of the upper case 400. The upper case 400 and projection 410 may be made of plastic.

The projection 410 of the upper case 400 is combined with the beading part 120a of the bare cell 100. More particularly, the projection 410 on the inner surface of the upper case 400 may be combined with the beading part 120a of the can 120 by the interference fit method. Thus, the projection 410 and beading part 120a is engaged with each other after they are combined, thereby improving bonding strength between the upper case 400 and bare cell 100.

FIGS. 9 to 13 are bottom views illustrating upper cases according to other various exemplary embodiments of the present invention.

Referring to FIG. 9, an upper case 600 includes at least three bar type projections 610 that are spaced apart from each other by a predetermined distance on an inner surface of the upper case 600. Referring to FIG. 9, sixteen projections 610 are shown being spaced apart from each other by a predetermined distance. Two of the sixteen projections 610 face each other, and the arrangements of the projections are symmetric about a terminal hole 601 of the upper case 600. However, the number and the arrangement of the projection 610 are not limited as long as at least three projections 610 are formed with a predetermined distance between each other.

The upper case 600 includes at least three projections 610 compared with the upper case 200 shown in FIG. 4. Thus, when the upper case 600 is combined with a bare cell, bonding strength between the upper case 600 and bare cell 100 can be more improved because more projections 610 are combined with a beading part 120a of the bare cell 100 by the interference fit method.

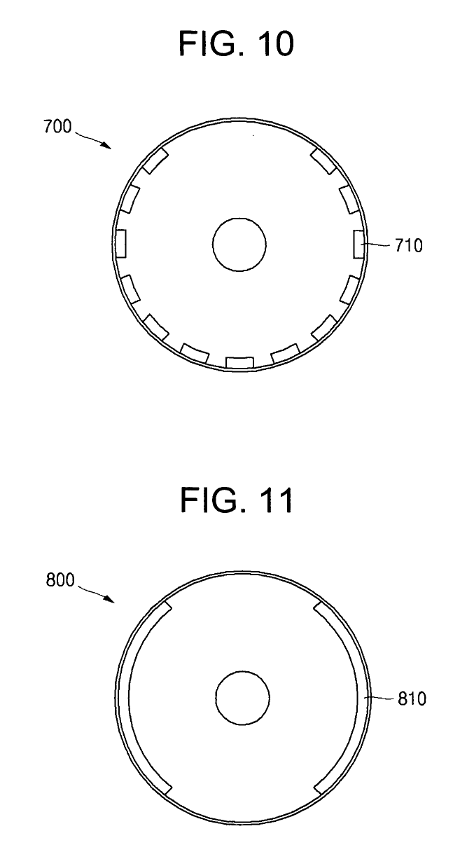

Referring to FIG. 10, an upper case 700 according to other exemplary embodiment includes at least three bar type projections 710 that are spaced apart from each other by a predetermined distance on an inner surface of the upper case 700.

However, the upper case 700 has a predetermined region of an inner surface that is not provided with the projection 710. In the upper case 600 of FIG. 9, projections 610 are arranged along a circumference of the inner surface of the upper case 600, but in the upper case 700 of FIG. 10, there is no projection in a predetermined circumference of the inner surface of the upper case 700. The reason for removing projections at the predetermined circumference is as follows. While a protection circuit module 500 is combined with a bare cell 100, the third module 530 crosses a portion of the beading part 120a. If a projection 710 is located at a position corresponding to the third module 530 and is combined with the beading part 120a, the third module 530 may be physically deformed or damaged, and the protection circuit module 500 may be disabled by the damage. For this reason, the projection 710 is not formed on the predetermined region of the inner surface of the upper case 700 in order to avoid the region where the third module 530 is located.

The upper case 700 may also include at least three projections 710 in comparison to the upper case 200 of FIG. 4. Thus, when the upper case 700 is combined with the bare cell 100, bonding strength between the upper case and bare cell 100 can be more improved because more projections 710 are combined with the beading part 120a of the bare cell 100 by the interference fit method.

Referring to FIG. 11, an upper case 800 according to other exemplary embodiment includes two bar type projections 810 that are spaced apart from each other by a predetermined distance on an inner surface of the upper case 800.

Each of the projections 810 of the upper case 800 contiguously extends along a circumference of the inner surface of the upper case 800, and is longer than the projection 210 of the upper case 200 shown in FIG. 4. Thus, when the upper case 800 is combined with the bare cell 100, bonding strength between the upper case and bare cell 100 can be more improved because the longer projection 810 is combined with a beading part 120a of the bare cell 100 by the interference fit method.

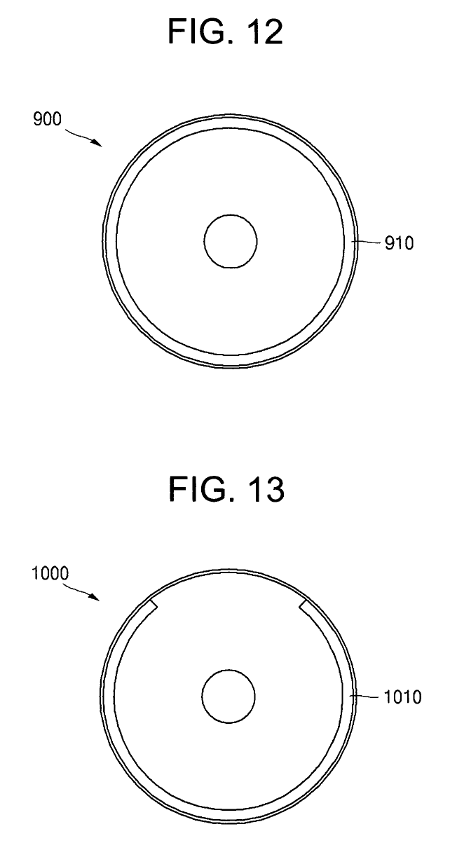

Referring to FIG. 12, an upper case 900 according to other exemplary embodiment includes a ring-shaped projection 910 provided on an inner surface of the upper case 900.

The projection 910 of the upper case 900 is longer in comparison to the projection 210 of the upper case 200 shown in FIG. 4. Thus, when the upper case 900 is combined with the bare cell 100, bonding strength between the upper case 900 and bare cell 100 can be more improved because the longer projection 910 is combined with a beading part 120a of the bare cell 100 by the interference fit method.

Referring to FIG. 13, an upper case 1000 according to other exemplary embodiment includes a ring-shaped projection 1010 provided on an inner surface of the upper case 1000, where a portion of the projection 1010 is opened. In other words, the ring-shaped projection 1010 is not a complete ring, but is open at a predetermined circumference of the inner surface of the upper case 1000. When the projection 1010 is located at a position corresponding to a third module 530 and a beading part 120a while a protection circuit module 500 is combined with a bare cell 100, the third module 530 may be physically deformed by the projection 1010 and the protection circuit module 500 may be disabled. For this reason, the portion of the ring-shaped projection 1010 is opened in order to avoid the region where the third module 530 is located.

The projection 1010 of the upper case 1000 is longer in comparison to the projection 210 of the upper case 200 shown in FIG. 4. Thus, when the upper case 1000 is combined with the bare cell 100, bonding strength between the upper case 1000 and bare cell 100 can be more improved because the longer projection 1010 is combined with the beading part 120a of the bare cell 100 by the interference fit method.

As described above, the battery pack of the present invention can improve bonding strength by combining the beading part of the bare cell with the projection on the inner surface of the case.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A battery pack comprising:
a bare cell comprising:
an electrode assembly for producing electricity;
a can receiving the electrode assembly and including a beading part inwardly pressed from an outer surface of the can, the beading part formed at a higher position than an upper part of the electrode assembly; and
a cap assembly covering an upper part of the can, and
an upper case covering the beading part and the upper part of the can, the upper case comprising a projection formed on an inner surface of the upper case, the projection being combined with the beading part.

2. The battery pack of claim 1, wherein more than one projection is provided on the inner surface of the upper case.

3. The battery pack of claim 2, wherein two of the projections face each other.

4. The battery pack of claim 1, wherein at least two projections are provided to be spaced apart from each other on the inner surface of the upper case.

5. The battery pack of claim 1, wherein the projection has a bar shape.

6. The battery pack of claim 1, wherein the projection has a ring shape.

7. The battery pack of claim 6, wherein a portion of the projection is opened.

8. The battery pack of claim 1, further comprising a protection circuit module electrically coupled to the bare cell.

9. The battery pack of claim 8, wherein the protection circuit module comprises:
a first module electrically coupled to a first electrode terminal of the bare cell and being substantially disk-shaped;
a second module electrically coupled to a second electrode terminal of the bare cell and being substantially disk-shaped; and
a third module electrically coupling the first module to the second module.

10. The battery pack of claim 9, wherein the first module comprises:
a first substrate;
a first plate provided at a middle of the first substrate; and
a device mounting portion provided on an inner surface of the first substrate, the device mounting portion surrounding the first plate.

11. The battery pack of claim 10, wherein the device mounting portion is arranged in a groove formed between the first electrode terminal and the can of the bare cell.

12. The battery pack of claim 9, wherein each of the first, second and third modules comprises a flexible printed circuit board.

13. The battery pack of claim 9, wherein the first module is disposed between the bare cell and the upper case.

14. The battery pack of claim 1, further comprising a lower case provided at a lower part of the bare cell.
